(19) United States
(12) Patent Application Publication
(10) Pub. No.: US 2026/0079289 A1
(43) Pub. Date: Mar. 19, 2026

(54) OPTICAL FILM FOR AUGMENTED REALITY DEVICES

(71) Applicant: Cambridge Enterprise Limited, Cambridge, Cambridgeshire (GB)

(72) Inventors: Pawan Kumar SHRESTHA, Cambridge, Cambridgeshire (GB); Xin CHANG, Cambridge, Cambridgeshire (GB); Daping CHU, Cambridge, Cambridgeshire (GB)

(21) Appl. No.: 19/109,317

(22) PCT Filed: Sep. 11, 2023
(86) PCT No.: PCT/EP2023/074938

§ 371 Date: Mar. 6, 2025

(30) Foreign Application Priority Data
Sep. 12, 2022 (GB) 2213313.6

(51) Int. Cl. G02B 5/28; G02B 1/10; G02B 5/18; G02B 5/20; G02B 27/01

(52) U.S. Cl. CPC G02B 5/285; G02B 1/10; G02B 5/1809; G02B 5/1866; G02B 5/203; G02B 27/0172; G02B 2027/0178; G02B 2207/101

(57) ABSTRACT

An optical element comprising a first wavelength band filter film including a diffractive optical structure, wherein the diffractive optical structure diffracts light including light in a first wavelength band so as to form a first array of optical focal points. The wavelength band filter film selectively performs one of reflecting and transmitting the light in the first wavelength band and selectively performs the other of reflecting and transmitting light outside the first wavelength band.

### FIELD OF THE INVENTION

The invention relates to an optical element for use in augmented reality (AR) and virtual reality (VR) head mounted displays (HMDs) and heads-up displays (HUDs).

### BACKGROUND

Augmented reality (AR) devices allow a user to experience and/or interact with virtual information without losing situational awareness of the real world. Such devices typically include a display device positioned close to the eye of a user, which displays images to the user while still allowing the user to see past the displayed images to remain aware of the external environment. Often AR devices take the form of a head mounted display (HMD), which is worn on the head of the user in the same way as a pair of glasses or a helmet. The display is positioned in front of one or both eyes of the user and typically takes the form of a partially transparent film through which an image is projected. The user can then see the image projected through the film overlayed onto the outside world.

Existing AR HMD products include Google Glass® and Microsoft Hololens®. HMD applications require the AR display to be compact, unintrusive, comfortable, and capable of producing high-quality images.

On the other hand, heads-up displays (HUDs) are transparent displays situated at the windscreen of an automobile or aircraft to present data without requiring drivers or pilots to look away from their usual viewpoints. Several car manufacturers including BMW® and Bentley® offer HUDs.

Each HMD device has an eyebox, which is defined as the area in which a user can move their eyes relative to the display and still see the complete projected image. It is desirable to have a large eyebox so that the user is able to see the image from different eye positions, especially during motion when the HMD can become misaligned. Furthermore, a large eyebox ensures a greater proportion of users can view the projected image without readjusting the HMD, taking into account the natural variation in face shapes and eye separation distances between users.

The field of view (FOV) of a display is defined as the angle subtended at the eye over which the user can see the displayed content. A large FOV increases the realism of the virtual content and the sense of immersion provided by an AR device, as well as enabling larger and more detailed images to be displayed. A small FOV is one of the most common complaints about existing AR displays, with many currently available HMDs only achieving less than 56° diagonal FOV and current HUDs offering less than 11°.

Free-space combiners are optical elements that are situated directly in front of the user's eyes in an AR HMD. The user can see the digital content overlayed on top of the real world through these optical elements. Free-space combiners can also perform other optical functions, such as lens functions, making them critical for the FOV and eyebox size of the AR device in which they are provided.

Waveguide combiners, unlike free-space combiners, are based on total internal reflection and are widely used in AR glasses to integrate multiple optical functions into a thin, transparent and lightweight substrate. Waveguide combiners generally include diffractive optical elements (DOEs) or holographic optical elements (HOEs) to relay the image from the image engine of the AR device to the eye.

It is desirable for an AR device to have a transparent and lightweight combiner that can produce a large FOV and eyebox. It is desirable to place the combiner as close to the eye as possible to improve the FOV of the device and also to make the AR device more compact. There are also conflicting requirements for the combiner to allow a user to view light coming from the real world with as little distortion as possible, while modifying the light coming from the image engine of the AR device to reflect and focus it.

Beam combiners comprised of conventional diffractive structures are compact and can fulfil the above requirements of an AR device combiner to an extent. However, existing beam combiners produce visually obtrusive rainbow-like colour dispersion when used with a generated AR image containing multiple colours or when used to view bright ambient light. Additionally, it is challenging to implement such diffractive structures with multiple colours.

### SUMMARY

According to an aspect of the invention, there is provided an optical element comprising a first wavelength band filter film including a diffractive optical structure, wherein the diffractive optical structure diffracts light including light in a first wavelength band so as to form a first array of optical focal points, the wavelength band filter film selectively performs one of reflecting and transmitting the light in the first wavelength band, and selectively performs the other of reflecting and transmitting light outside the first wavelength band.

The combination of a diffractive structure with a narrowband thin film provides a compact film that can fulfil the optical functions required in the combiner of an AR device, including a lensing function producing multiple exit pupils. These optical functions can be provided by the diffractive patterning of the film. At the same time, the film appears transparent to visible light and significantly reduces rainbow-like colour dispersion effect due to the presence of the narrowband filter.

The film of the invention enables a transparent and clear AR display with a large FOV and a large eyebox while maintaining an always in-focus image. When used as a reflector, the film can have a high transparency as it only reflects a very narrow wavelength band due to the presence of the narrowband filter. The film can be used in both free space and waveguide optical combiners.

Preferably, the optical focal points form an array of points lying in a manifold separated from the surface of the film.

Preferably, the focal points are regularly spaced from each other.

Preferably, the diffractive optical structure comprises a pattern of recesses or holes formed in the wavelength band film.

Preferably, the wavelength band filter film has a wavelength band falling within one or both of the visible light wavelength band and the infrared light wavelength band.

Preferably, the wavelength band filter film is a transmissive filter that transmits a wavelength band having a full width half maximum of 50 nm or less.

Preferably, the wavelength band filter film is a reflective filter that reflects a wavelength band having a full width half maximum of 50 nm or less.

Suitably, the wavelength band filter film is a notch filter film.

Preferably, the wavelength band filter film is a narrowband reflector film.

Preferably, the wavelength band filter film comprises a metastructure.

More preferably, the metastructure is a metasurface having a unit structure comprising one of the group consisting of: elliptical nanopillar pairs, rectangular nanopillars with notches, hollow nanopillars distributed in a square two-dimensional lattice, circular nanopillars periodically arranged in a square two-dimensional lattice, nanopillars with an elliptical cross-section periodically arranged in a square lattice, and multilayer nanopillars with a circular cross-section.

Preferably, the nanopillars of the metasurface are made of TiO₂.

Preferably, the one or more nanopillars in the unit structure are provided in air.

Alternatively, the one or more nanopillars in the unit structure are encapsulated in an organic polymer material.

In one embodiment, the metasurface has a unit structure comprising one or more multilayer nanopillars, wherein each multilayer nanopillar includes a base layer of Al₂O₃, an intermediate layer of TiO₂ formed on the base layer, and a top layer of SiO₂ formed on the intermediate layer.

Preferably, the wavelength band filter film has a layer structure comprising one of alternating Al₂O₃/SiO₂ layers, alternating HfO₂/SiO₂ layers, alternating TiO₂/SiO₂ layers, and alternating Ta₂O₅/SiO₂ layers.

Preferably, the optical element further comprises a second wavelength band filter film having a second diffractive optical structure, wherein the second diffractive optical structure diffracts light including light in a second wavelength band so as to form a second array of optical focal points, the second wavelength band filter film selectively performs one of reflecting and transmitting the light in the second wavelength band, and selectively performs the other of reflecting and transmitting light outside the second wavelength band, and the second wavelength band does not overlap with the first wavelength band.

Suitably, the optical element further comprises a third wavelength band filter film having a third diffractive optical structure, wherein the third diffractive optical structure diffracts light including light in a third wavelength band so as to form a third array of optical focal points, the third wavelength band filter film selectively performs one of reflecting and transmitting the light in the third wavelength band, and selectively performs the other of reflecting and transmitting light outside the third wavelength band, and wherein the third wavelength band does not overlap with the first wavelength band or the second wavelength band.

Preferably, the diffractive optical structure is a holographic optical structure.

According to another aspect of the invention, there is provided a free space combiner for an augmented reality or virtual reality device comprising the optical element described above.

According to another aspect of the invention, there is provided a waveguide combiner for an augmented reality or virtual reality device comprising the optical element described above.

According to another aspect of the invention, there is provided an augmented reality or virtual reality device comprising a combiner as described above and a light source configured to project light onto the combiner to form an image, wherein the light source is configured to project light having a wavelength within the first wavelength band.

According to another aspect of the invention, there is provided an augmented reality or virtual reality device comprising a combiner comprising the optical element described above, a first light source configured to project light onto the combiner to form an image, wherein the first light source is configured to project light having a wavelength within the first wavelength band, and a second light source configured to project light onto the combiner to form an image, wherein the second light source is configured to project light having a wavelength within the second wavelength band.

Preferably, the above augmented reality or virtual reality device further comprises a third light source configured to project light onto the combiner to form an image, wherein the third light source is configured to project light having a wavelength within a third wavelength band, wherein the third wavelength band does not overlap with the first wavelength band or the second wavelength band.

Preferably, there is provided a virtual reality device as described above, further comprising a light shield configured to block outside light from reaching the combiner.

### BRIEF DESCRIPTION OF THE DRAWINGS

Embodiments of the present invention will now be described by way of further example only and with reference to the accompanying drawings, in which:

FIG. 1 is a perspective view of a film according to an embodiment operating as a combiner in an AR device;

FIG. 2 is a top-down plan view of AR glasses including the film of the embodiment operating as a combiner;

FIG. 3 represents a front-on view of an eyebox showing focal points produced by a film according to an embodiment;

FIG. 4 is a perspective view of a film according to an embodiment operating as a combiner in a VR device;

FIG. 5 is a perspective view of a film according to an embodiment operating as a combiner in an alternative VR device;

FIG. 6 is an example of a full colour display arrangement using a film according to an embodiment including three hologram layers;

FIG. 7 is a perspective view of a film according to an embodiment operating as a combiner in AR glasses, showing an image engine projecting light onto the film;

FIG. 8 shows a cross-section view of unit structures in XY and XZ planes of a metasurface design used in a first example;

FIG. 9 shows the reflection spectrum of the metasurface of the first example;

FIG. 10 shows a cross-section view of unit structures in XY and XZ planes of a metasurface design used in a second example;

FIG. 11 shows the reflection spectrum of the metasurface of the second example;

FIG. 12 shows a cross-section view of unit structures in XY and XZ planes of a metasurface design used in a third example;

FIG. 13 shows the reflection spectrum of the metasurface of the third example;

FIG. 14 shows a cross-section view of unit structures in XY and XZ planes of a metasurface design used in a fourth example;

FIG. 15 shows the reflection spectrum of the metasurface of the fourth example;

FIG. 16 shows a cross-section view of unit structures in XY and XZ planes of a metasurface design used in a fifth example;

FIG. 17 shows the reflection spectrum of the metasurface of the fifth example;

FIG. 18 shows a cross-section view of unit structures in XY and XZ planes of a metasurface design used in a sixth example;

FIG. 19 shows the reflection spectrum of the metasurface of the sixth example;

FIG. 20 shows a cross-section view of unit structures in XY and XZ planes of a metasurface design used in a seventh example;

FIG. 21 shows the reflection spectrum of the metasurface of the seventh example;

### DETAILED DESCRIPTION

An embodiment of the invention comprises a wavelength band filter film. Examples of suitable wavelength band filter films include narrowband reflectors, notch filter films and films including a metastructure.

An example of a suitable commercially available notch filter film suitable as a substrate for the optical element is product code NF514-17 produced by Thorlabs®. This film reflects a wavelength band centered on 514 nm and having a full width half maximum (FWHM) of 17 nm. For the purposes of this description, a narrowband filter is defined as a filter that reflects or transmits a wavelength band having a FWHM of 50 nm or less, and preferably 20 nm or less. In more preferred embodiments, the filter has a FWHM of 15 nm or less. Effective reflected light intensity of the desired wavelength can be modulated by altering the depth of a diffractive pattern imprinted onto the narrowband film, which may be a holographic pattern.

The inventors have found that notch filter films with particularly advantageous optical properties can be formed from multiple alternating Al₂O₃/SiO₂ layers. Other preferable materials for the notch filter film include multiple alternating hafnium (IV) oxide (HfO₂)/silicon dioxide (SiO₂) layers, titanium dioxide (TiO₂)/SiO₂ layers, or tantalum pentoxide (Ta₂O₅)/SiO₂ layers.

Suitable wavelength band filter films can also be formed by metastructures such as metasurfaces. A metastructure is a structure composed of an array of unit structures that have a size and spacing below the wavelength of the light with which the surface is designed to be used. A metastructure for visible wavelengths typically has a structure dimension below 1 micrometre. A metasurface is a type of metastructure comprising a surface composed of the array of unit structures discussed above.

Depending on the design of the unit structures, metasurfaces can provide multidimensional light modulation of properties such as polarization, phase, amplitude, and orbital angular momentum. In the invention, a metasurface can be used to provide a film having a highly saturated structural colour, which is equivalent to a narrow-bandwidth wavelength filter.

Suitable metasurfaces can be formed from various known materials, including TiO₂, SiO₂ and Al₂O₃. The inventors have found that metasurfaces with particularly advantageous optical properties can be formed from TiO₂ layers. To achieve the narrowband filtering effect of the invention, these materials are used to form unit structures having various possible designs, discussed in detail below.

The wavelength band filter film is patterned to produce a diffractive and preferably holographic lens structure comprising multiple diffractive lenses in an array across the surface of the film. These lenses focus incoming light at different points, which allows the film to create an expanded eyebox when it is used as a combiner in an AR HMD device. The focal points of the multiple lenses are typically arrayed on a manifold away from the surface of the film. These points correspond to possible positions of the user's eye to view a virtual image correctly in the AR HMD.

In this example, the surface of the film contains a pattern of recesses or holes of various predetermined depths formed in the film, producing a two-dimensional hologram. The recesses or holes and the unpatterned parts of the film effectively form pixels in a relief image on the surface of the film, which in turn forms the hologram. This type of pattern can be created by known computer generated holography techniques so as to produce the desired array of diffractive lenses on the film. The pattern can be physically created on the film by performing e-beam lithography or other nanofabrication techniques.

Existing holographic lenses lead to the bending of different wavelengths of light incident on the lens at different angles, creating a chromatically aberrated image. This is undesirable as such lenses cannot be used in devices operating with multiple colours. Furthermore, the user sees rainbow-like dispersion when any external bright light is viewed through the lens. This has limited the usefulness of holographic lenses for applications such as AR devices.

In the invention these chromatic aberration problems are minimized by fabricating a hologram out of a narrowband reflector, a notch filter (based on a thin-film of a distributed Bragg reflector) or a metasurface as discussed above. Such layers are designed to reflect only a narrow bandwidth (for example less than 15 nm per colour) of light and appear transparent to the rest of the visible spectrum.

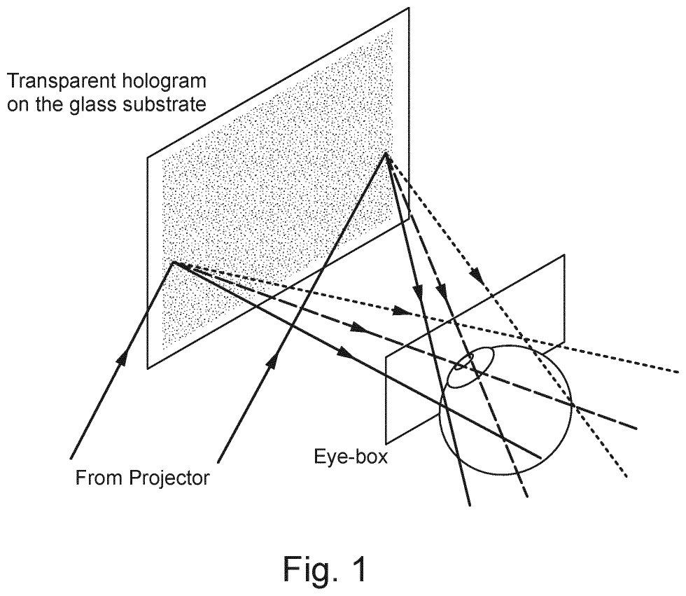

FIG. 1 is a perspective view of a film according to the embodiment operating as a combiner in an AR device, showing the eyebox created by the film when light is projected onto the hologram surface of the film. In a typical AR device, a light engine (such as one or more scanning laser projectors) projects light onto the combiner film and light in the wavelength band selected by the filter film is reflected and focused by the diffractive lenses formed by patterning the film. Other light engines such as micro LED (light emitting diode) and OLED (organic light emitting diode) light sources can also be used. The resulting focal points themselves form an array across the eyebox of the device.

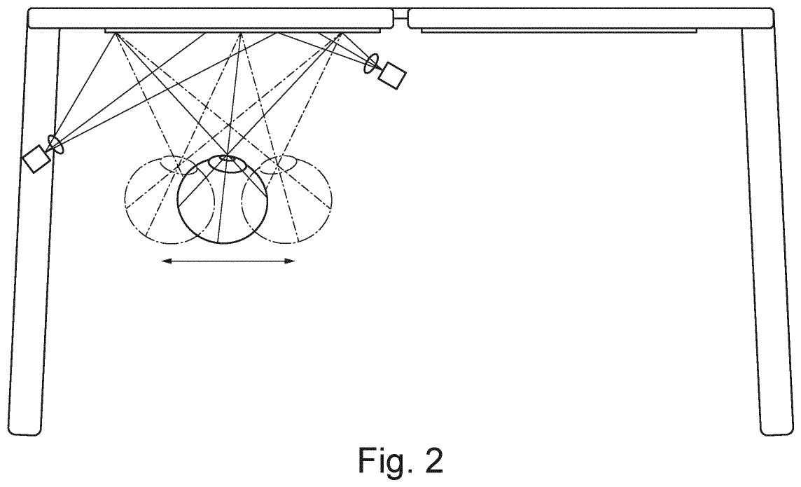

FIG. 2 shows a similar arrangement to that of FIG. 1 in a pair of AR glasses, viewed from above. In FIG. 2 two light engines are shown projecting light onto the combiner film, but using a single light engine is also possible.

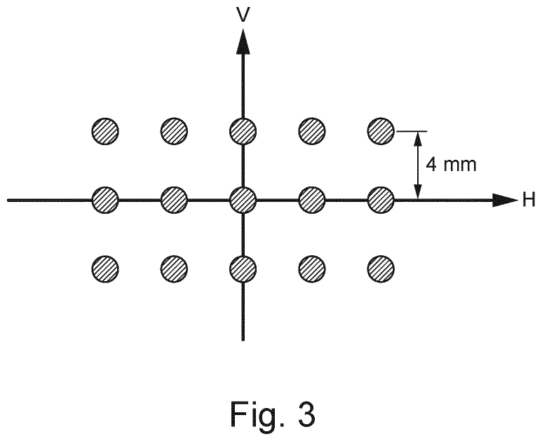

FIG. 3 is a view of the eyebox showing the focal or convergence points produced by the film according to the invention from the perspective of the user's eye. The focal points form an array of points lying in a manifold separated from the surface of the film. The manifold can be a flat plane but a curved surface is preferred, so as to match the positions of the focal points across the eyebox with possible positions of the user's eye.

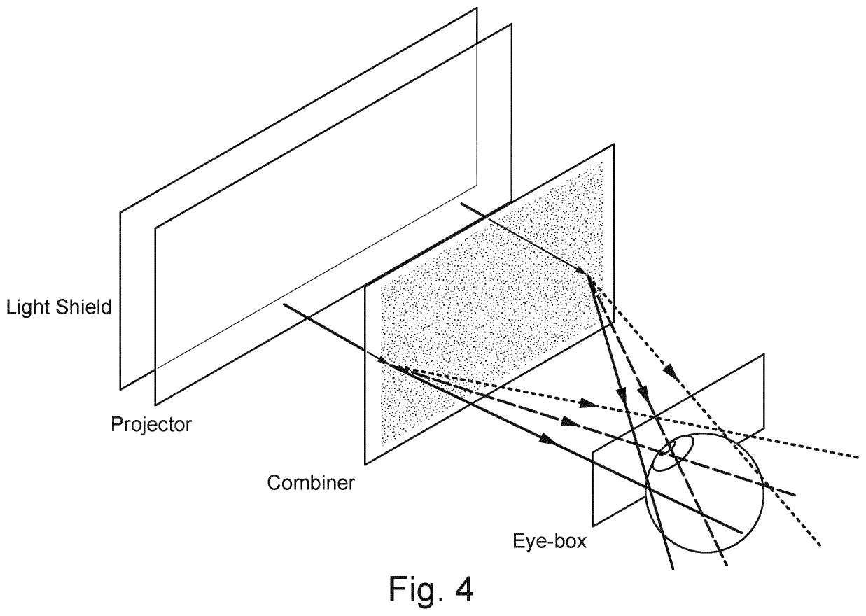

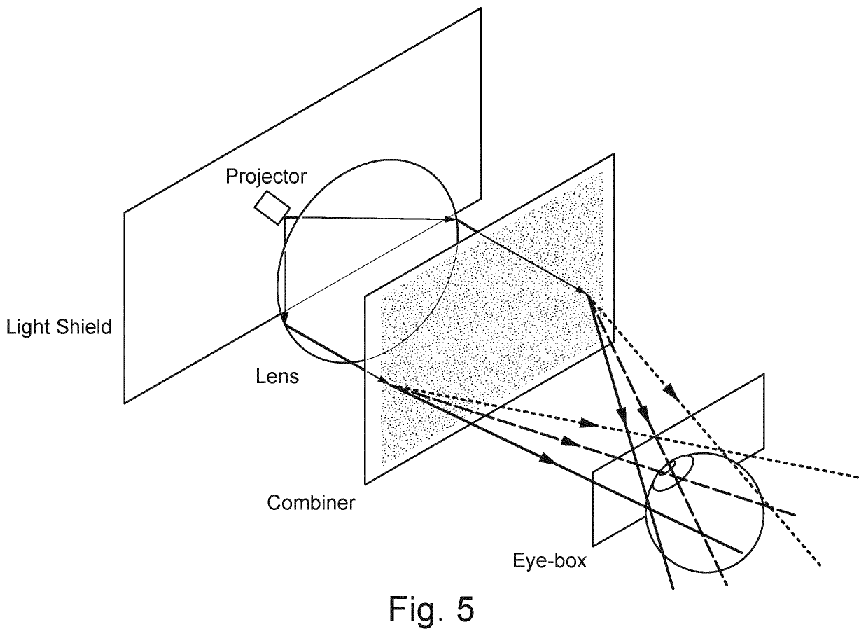

When the combiner is used in a VR device rather than an AR device, a light shield is placed on the far side of the combiner from the eyebox so as to block out light from the outside world. This means that only light from the light engine reaches the user's eye via the combiner in the VR device. This is illustrated in FIG. 4, which is a VR device including a light shield and a projector placed between the light shield and the combiner. Similarly, FIG. 5 shows a VR device having a projector and a projection lens positioned between the light shield and the combiner.

For a multicolour display, the invention uses a combination of several wavelength band filter films tuned to different wavelengths of visible light matching the colours of the display. In the completed AR device, a plurality of light sources having different wavelengths are used to project the image onto the film. The wavelength band filter films within the optical element are respectively tuned to the same wavelengths as the lasers. Typically three light sources and three corresponding wavelength band filter films are used, each film being tuned to a wavelength band matching one of the display colours red (around 640 nm), green (around 525 nm) and blue (around 450 nm). This results in a conventional RGB display type.

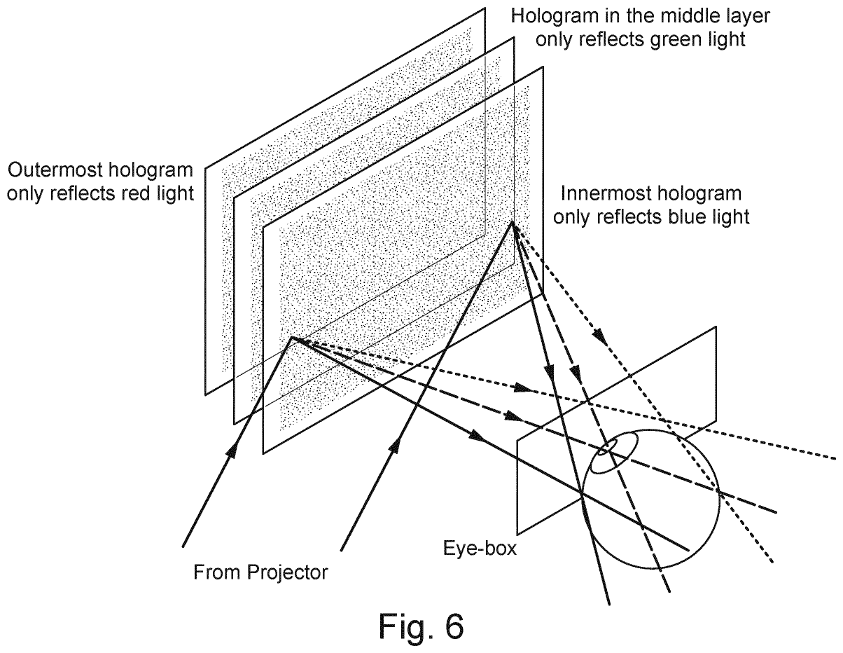

An example of a full colour display arrangement using a film according to the invention is shown in FIG. 6. The three holographic film layers respectively reflect red, green and blue light from the image projector. Since each film layer only reflects light in a narrow wavelength band around the wavelength of the light from the projector, almost all external light is transmitted through the film layers to the user's eye. This means that the user retains a clear view of the outside world. Even with three reflective films according to the invention, the total bandwidth of wavelengths reflected by the films is typically less than 50 nm, i.e. a small fraction of the total visible light wavelength band, which extends from around 400 nm to around 700 nm.

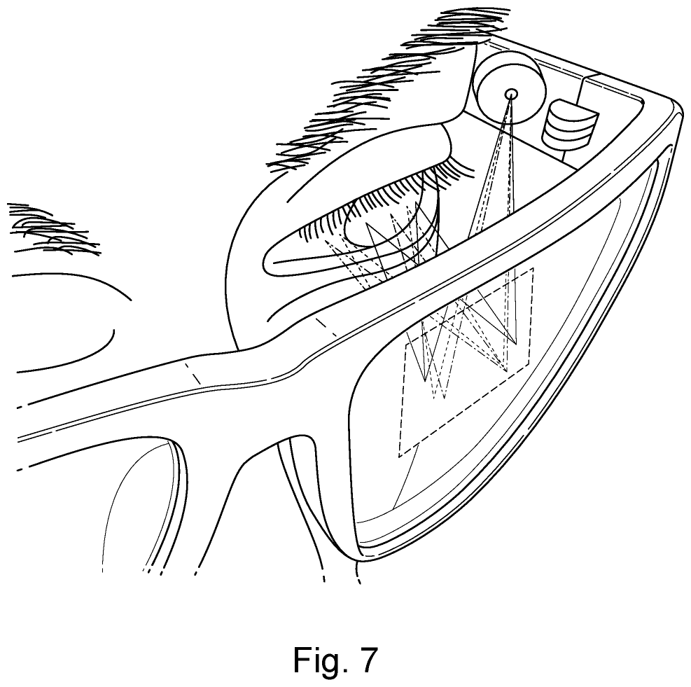

FIG. 7 shows a similar full colour display arrangement to that of FIG. 6 incorporated into a pair of AR glasses. A light engine is shown projecting red, green and blue light onto the three holographic film layers making up the combiner film, which in turn reflects and diffracts the light to form a colour image on the user's eye.

In alternative embodiments, it is possible to provide a colour display by using three differently coloured light sources and only two wavelength band filter films, one of the films having two wavelength bands corresponding to the wavelength bands of two of the light sources.

### EXAMPLES

### Notch Filter Example

In the first example, a diffractive optical element comprising a 2D grating with a pitch of 100 μm was written by laser ablation on a notch filter. The notch filter was product code NF514-17 produced by Thorlabs®. Product NF514-17 is designed to reflect a 514 nm wavelength with a full width half maximum of 17 nm and transmits the rest of the visible wavelengths.

Testing on the example demonstrated that the diffractive pattern, i.e. the 2D grating, written on the wavelength-selective reflective layer, i.e. the notch filter, will only diffract light of the designed wavelength. A red laser (wavelength 632.8 nm) and a green laser (wavelength 515 nm) were diffracted consecutively by the optical element to demonstrate this. It was observed that the green pattern produced by the optical element diffracting the green laser was 28 times brighter than the red pattern produced by the optical element diffracting the red laser. A faint diffraction pattern was generated by the red laser, which is thought to be due to specular reflection.

### METASURFACE EXAMPLES

The inventors have developed several metasurface designs that achieve the narrow-band optical filtering of the invention. Holographic lenses formed using these metasurfaces reflect light with a narrow wavelength bandwidth and work under perpendicular or oblique incident light with certain angles of incidence (AOI).

The material used for these metasurface designs is titanium dioxide (TiO₂) due to its high energy bandgap and relatively high refractive index (refractive index of approximately 2.5). Alternatively, gallium nitride (GaN) or another high refractive index material can be used to replace TiO₂ in metasurfaces.

The substrate material on which the metasurfaces are formed is glass, having a refractive index of approximately 1.5.

Each metasurface is composed of unit structures that are arranged periodically in a planar square lattice. The figures show the unit structures of the designs rather than the entire lattice. Other lattice structures such as a hexagonal lattice can also be used.

### Metasurface Example 1

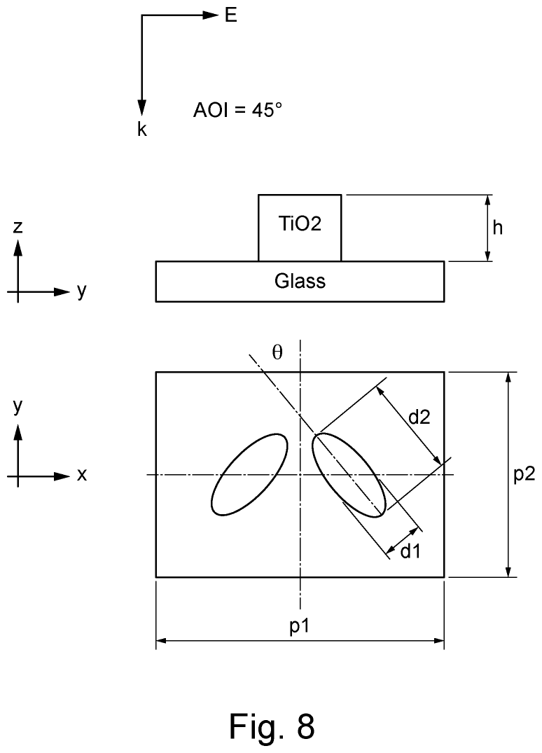

FIG. 8 shows a cross-section view of the unit structures in XY and XZ planes of a first metasurface design suitable for use in the invention. The angle of incidence (AOI) of the incident light E is shown at the top of the figure. This metasurface comprises elliptical TiO₂ nanopillar pairs in the air.

The compound unit structure is composed of one pair of elliptical nanopillars, meaning pillars that have an elliptical cross-section and are elliptical in plan view. Each nanopillar has a height h, a short axis length d1, and a long axis length d2. Each nanopillar is oriented at an angle θ between its long axis and a global Y axis. The centre of each nanopillar is at coordinates dx, dy with respect to the centre of the unit structure. The design parameters used in this example are listed in Table 1 below. The polarization direction is along the Y axis and the incident light is in the YZ plane.

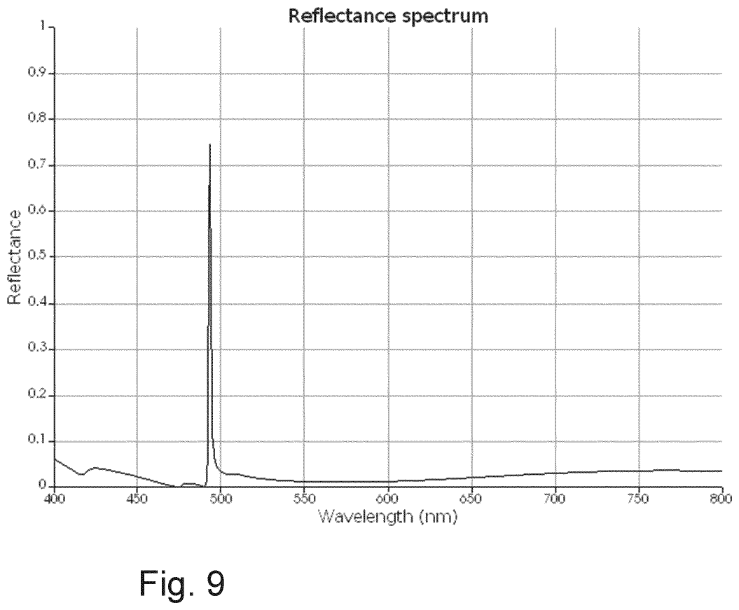

FIG. 9 shows the reflection spectrum of the metasurface of this example. This symmetry-broken and symmetry-protected design suppress the dominant fraction of scattering loss from the metasurface, thus leading to a narrow reflection bandwidth as desired for the film of the invention.

TABLE 1

| | | |
|---|---|---|
| Height (h) | 140 | nm |
| Diameter 1 (d1) | 90 | nm |
| Diameter 2 (d2) | 190 | nm |
| Centre X coordinate (dx) | 90 | nm |
| Centre y coordinate (dy) | 0 | nm |
| Period 1 (p1) | 360 | nm |
| Period 2 (p2) | 230 | nm |
| Angle (θ) | 25 | degrees |

### Metasurface Example 2

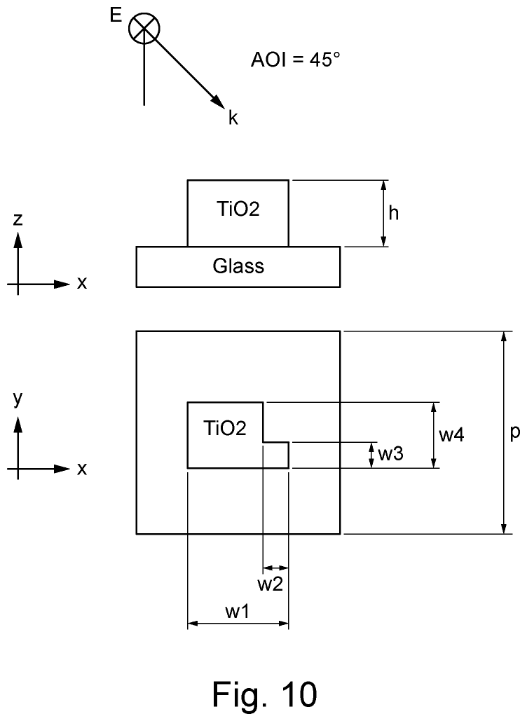

FIG. 10 shows a cross-section view of the unit structure in XY and XZ planes of a second metasurface design suitable for use in the invention. The angle of incidence (AOI) of the incident light E is shown at the top of the figure. This metasurface comprises rectangular TiO₂ nanopillars with notches in the air.

The unit structure is composed of a TiO₂ nanopillar with a rectangular cross-section having a notch. The notch also has a rectangular cross-section in plan view and is positioned at one corner of the pillar in cross-section. This results in a pillar having an L shape in plan view.

The pillar has a height h and widths w1 and w4 in the X and Y directions respectively, ignoring the notch. The nanopillar is positioned at the centre of the unit structure. On one side of the nanopillar, a notch having widths w2 and (w4−w3) in the X and Y directions respectively is created to break the rotational symmetry of the pillar. The notch is formed through the entire height of the pillar in this example.

The design parameters used in this example are listed in Table 2 below.

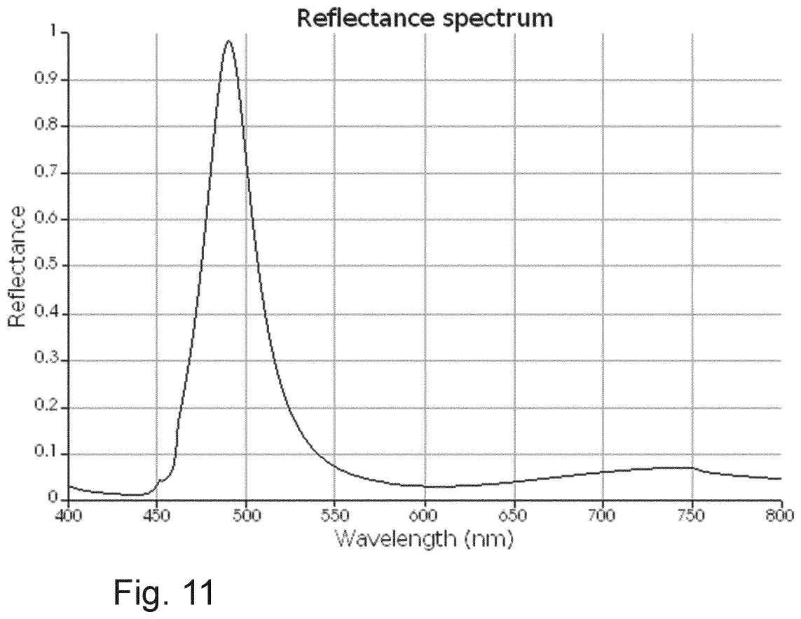

FIG. 11 shows the reflection spectrum of the metasurface of this example. The existence of the notch breaks the rotational symmetry of the unit structure and induces destructive interference between modes of distinctive damping within the same nanopillar. The non-radiative decay is small with this design, and this leads to a narrow reflection bandwidth.

TABLE 2

| | | |
|---|---|---|
| Height (h) | 140 | nm |
| Width 1 (w1) | 230 | nm |
| Width 2 (w2) | 50 | nm |
| Width 3 (w3) | 50 | nm |
| Width 4 (w4) | 180 | nm |
| Period (p) | 340 | nm |

### Metasurface Example 3

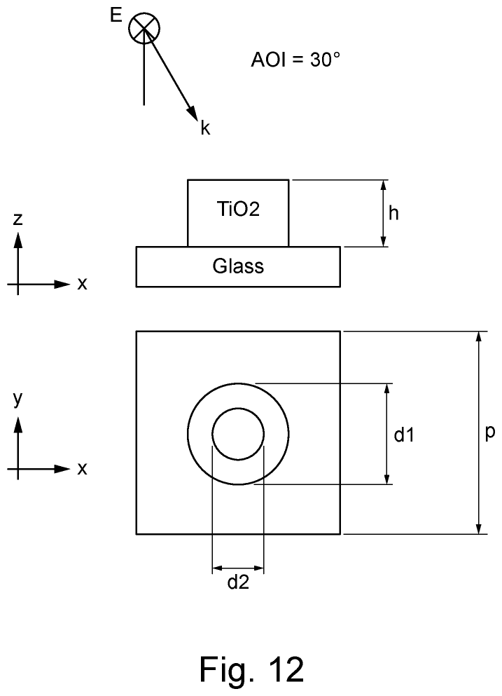

FIG. 12 shows a cross-section view of the unit structure in XY and XZ planes of a third metasurface design suitable for use in the invention. The angle of incidence (AOI) of the incident light E is shown at the top of the figure. This metasurface comprises hollow TiO₂ nanopillars having a diameter d1 and a height h that are distributed in a square 2-dimensional lattice of period p in air.

A cylindrical empty volume of diameter d2 is formed in the centre of each TiO₂ nanopillar forming the unit structure. The hollow volume of the nanopillar effectively modifies the refractive index at the centre of the nanopillar. From another point of view, the hollow volume affects the distribution of induced displacement current and changes the mode excited in the nanopillar.

The position of the circular empty volume can also be off-centre in the TiO₂ nanopillars. The cross-sectional areas of the TiO₂ nanopillars and the empty volumes within them can be modified freely. The TiO₂ nanopillars can also be square in cross-section, among other possible shapes.

The design parameters used in this example for an AOI of 30 degrees are listed in Table 3 below.

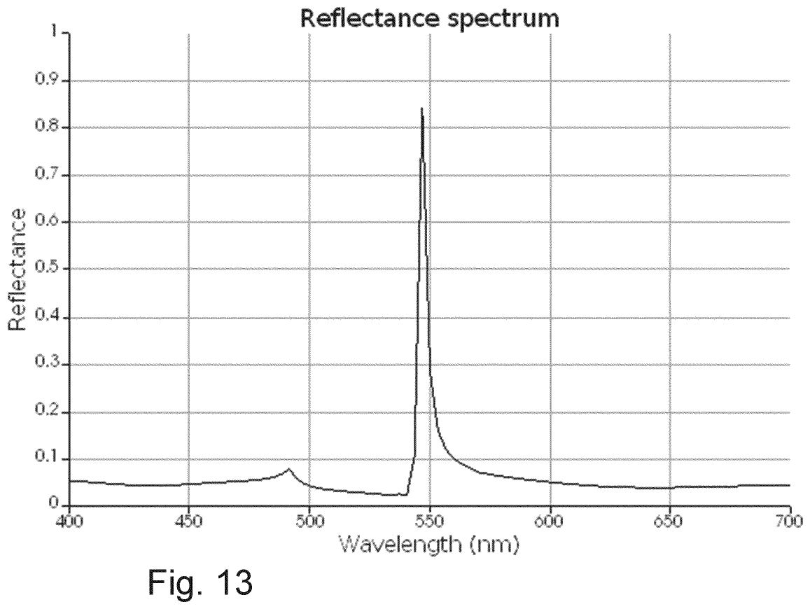

FIG. 13 shows the reflection spectrum of the metasurface of this example.

TABLE 3

| | |
|---|---|
| Height (h) | 250 nm |
| Diameter 1 (d1) | 290 nm |
| Diameter 2 (d2) | 210 nm |
| Period (p) | 380 nm |

### Metasurface Example 4

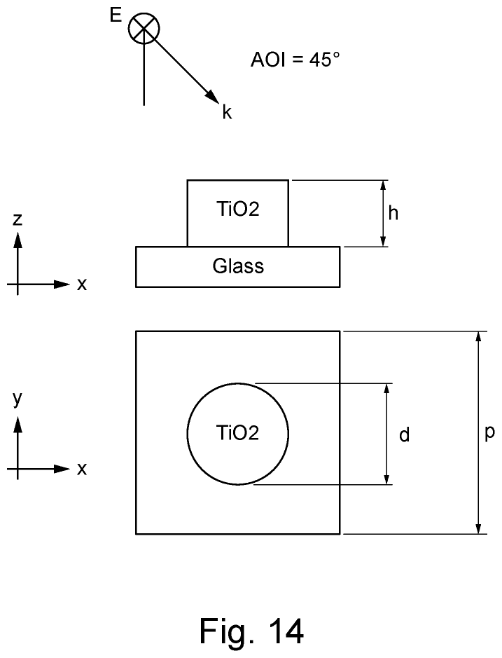

FIG. 14 shows a cross-section view of the unit structure in XY and XZ planes of a fourth metasurface design suitable for use in the invention. The angle of incidence (AOI) of the incident light E is shown at the top of the figure. This metasurface comprises circular TiO₂ nanopillars of height h and diameter d, which are periodically arranged in a square lattice that has a lattice constant or period p.

The metasurface is in an ambient air environment. Although the unit structure in this example has a circular cross-section, square cross-sections for pillars of height h and side length d, among other shapes, are also possible. This example is based on Mie scattering, in which different modes are excited (the fundamental mode being the magnetic dipole mode) inside the nanopillars by incident light through the excitation of a displacement current.

The design parameters used in this example for an AOI of 45 degrees are listed in Table 4 below.

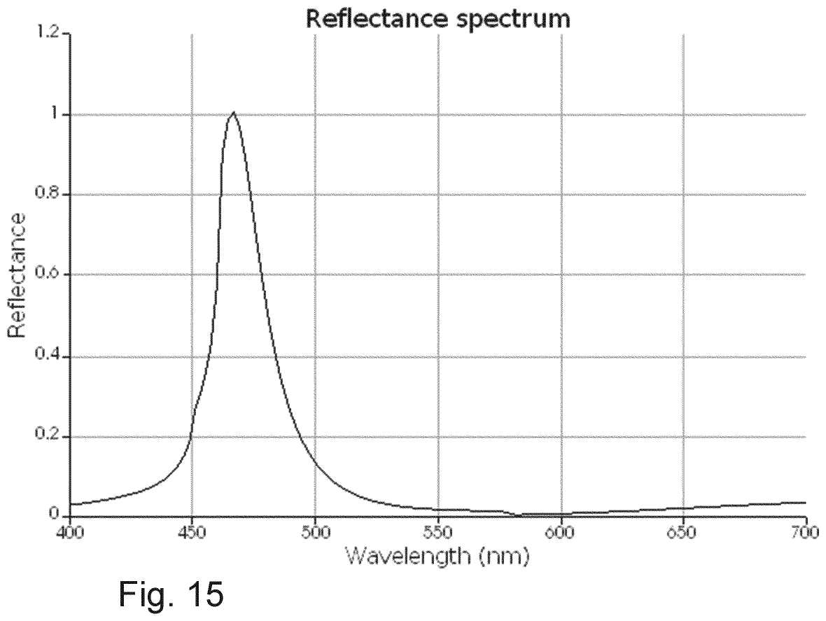

FIG. 15 shows the reflection spectrum of the metasurface of this example.

TABLE 4

| | |
|---|---|
| Height (h) | 140 nm |
| Diameter (d) | 180 nm |
| Period (p) | 340 nm |

### Metasurface Example 5

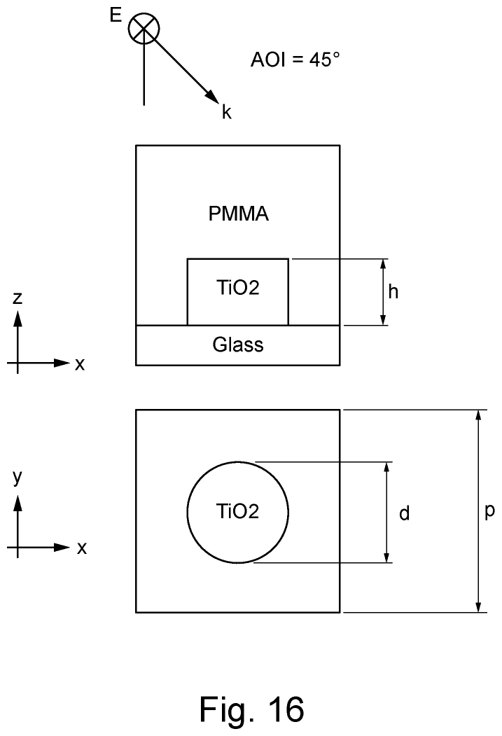

FIG. 16 shows a cross-section view of the unit structure in XY and XZ planes of a fifth metasurface design suitable for use in the invention. The angle of incidence (AOI) of the incident light E is shown at the top of the figure. This metasurface comprises TiO₂ nanopillars having a circular cross-section with a diameter d and a height h, periodically arranged in a square lattice that has a lattice constant or period p.

This metasurface differs from example 4 in that the nanopillars are encapsulated in Poly(methyl methacrylate) (PMMA) using a vacuum process. The index of refraction for PMMA is 1.48, which is close to that of the glass substrate. Other organic polymers can be used instead of PMMA in modified examples, such as polydimethylsiloxane (PDMS). By substantially matching the indexes of the encapsulation environment of the metasurface and the substrate, reflections at undesired wavelengths can be minimised. This helps to narrow the bandwidth of light reflected from the metasurface further.

The design parameters used in this example for an AOI of 45 degrees are listed in Table 5 below.

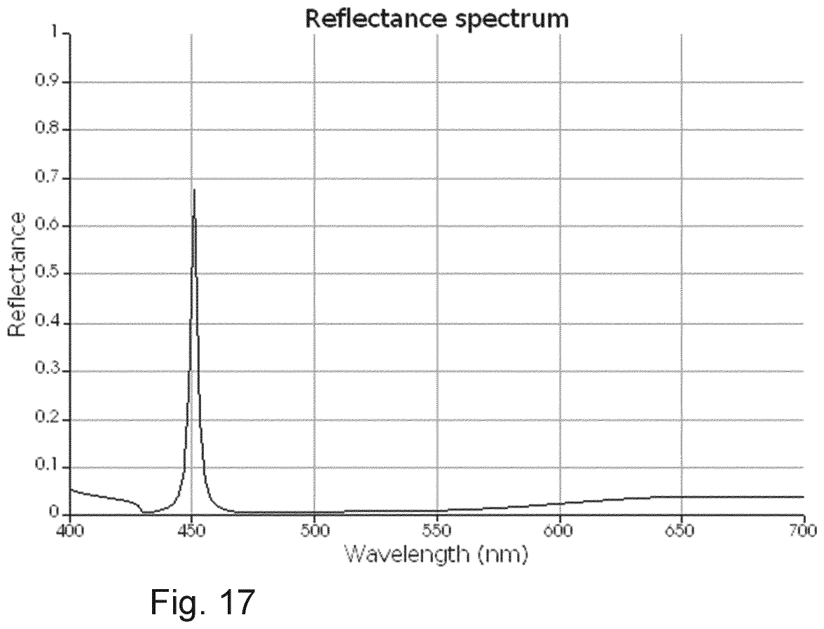

FIG. 17 shows the reflection spectrum of the metasurface of this example.

TABLE 5

| | |
|---|---|
| Height (h) | 140 nm |
| Diameter (d) | 140 nm |
| Period (p) | 300 nm |

### Metasurface Example 6

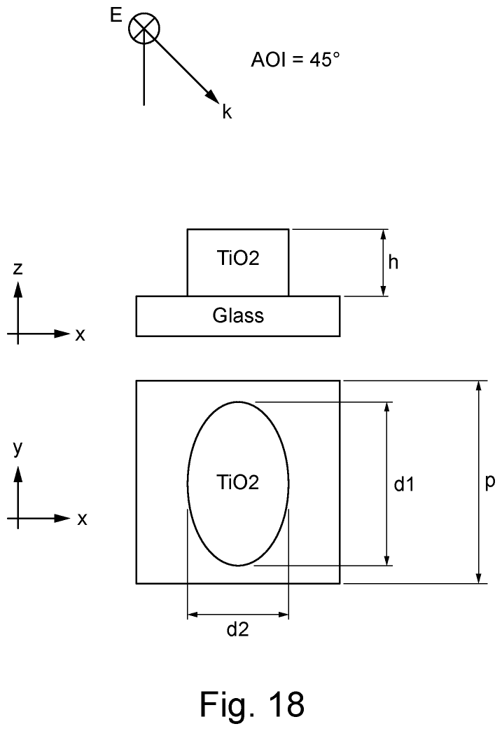

FIG. 18 shows a cross-section view of the unit structure in XY and XZ planes of a sixth metasurface design suitable for use in the invention. The angle of incidence (AOI) of the incident light E is shown at the top of the figure. This metasurface comprises TiO₂ nanopillars with an elliptical cross-section having a long axis d1, a short axis d2 and a height h. The nanopillars are periodically arranged in a square lattice that has a lattice constant or period p.

In this example, the nanopillars forming the metasurface have an asymmetric cross-sectional shape. On the one hand, this increases the dependency of the optical properties of the metasurface on the polarization of incident light. On the other hand, this property of the metasurface offers a narrower reflection bandwidth and decreases the dependency of the reflection properties on the AOI.

The design parameters used in this example for an AOI of 45 degrees are listed in Table 6 below.

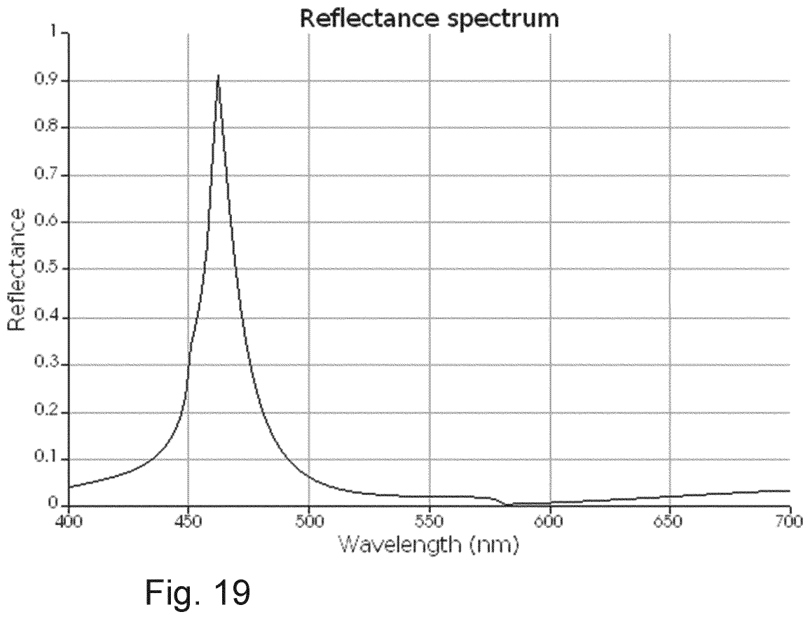

FIG. 19 shows the reflection spectrum of the metasurface of this example.

TABLE 6

| | |
|---|---|
| Height (h) | 140 nm |
| Diameter 1 (d1) | 180 nm |
| Diameter 2 (d2) | 160 nm |
| Period (p) | 300 nm |

### Metasurface Example 7

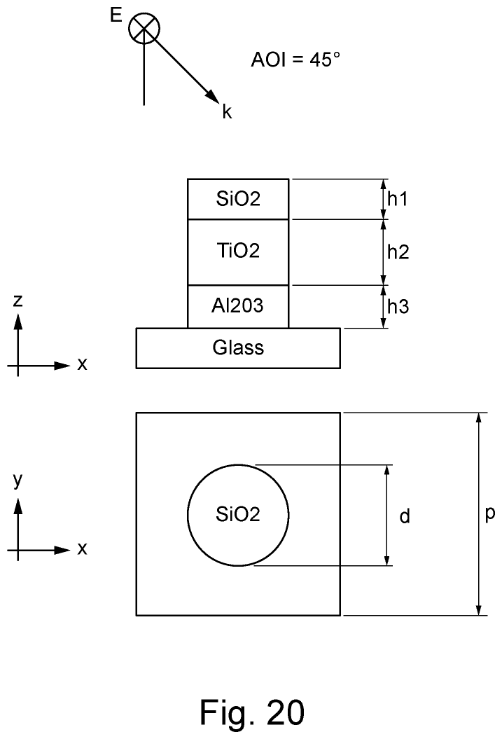

FIG. 20 shows a cross-section view of the unit structure in XY and XZ planes of a seventh metasurface design suitable for use in the invention. This metasurface comprises multilayer nanopillars with a circular cross-section having a diameter d and a total height of h=h1+h2+h3.

In the multilayer nanopillar structure, a middle layer of TiO₂ having a height h2 is sandwiched between an upper layer of SiO₂ having a refractive index of approximately 1.46 and a height h1, and a lower layer of Al₂O₃ having a refractive index of approximately 1.68 and a height h3. The upper SiO₂ layer serves to match the refractive indices of the air and the TiO₂ middle layer. The lower Al₂O₃ layer serves to match the refractive indices of the substrate and the TiO₂ middle layer.

The multilayer nanopillars are distributed in a square lattice of period p. The cross-sections of the multilayer nanopillars can also be square in modified examples, among other shapes.

The design parameters used in this example are listed in Table 7 below.

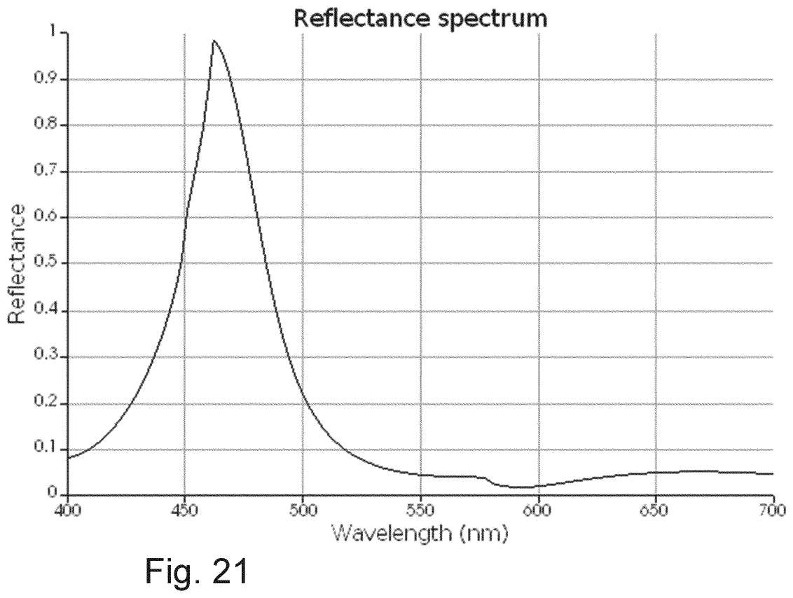

FIG. 21 shows the reflection spectrum of the metasurface of this example.

TABLE 7

| | | |
|---|---|---|
| Height of SiO₂(h1) | 100 | nm |
| Height pf TiO₂(h2) | 140 | nm |
| Height of Al₂O₃(h3) | 60 | nm |
| Diameter (d) | 190 | nm |
| Period (p) | 380 | nm |

The foregoing description has been given by way of example only and it will be appreciated by a person skilled in the art that modifications can be made without departing from the scope of the present invention as defined by the claims.

1. An optical element comprising a first wavelength band filter film including a diffractive optical structure, wherein
the diffractive optical structure diffracts light including light in a first wavelength band so as to form a first array of optical focal points,
the wavelength band filter film selectively performs one of reflecting and transmitting the light in the first wavelength band, and selectively performs the other of reflecting and transmitting light outside the first wavelength band.

2. The optical element of claim 1, wherein the optical focal points form an array of points lying in a manifold separated from the surface of the film.

3. (canceled)

4. The optical element of claim 1, wherein the diffractive optical structure comprises a pattern of recesses or holes formed in the wavelength band film.

5. The optical element of claim 1, wherein the wavelength band filter film has a wavelength band falling within one or both of the visible light wavelength band and the infrared light wavelength band.

6. The optical element of claim 1, wherein the wavelength band filter film is a transmissive filter that transmits a wavelength band having a full width half maximum of 50 nm or less.

7. The optical element of claim 1, wherein the wavelength band filter film is a reflective filter that reflects a wavelength band having a full width half maximum of 50 nm or less.

8. The optical element of claim 1, wherein the wavelength band filter film is a notch filter film.

9. The optical element of claim 1, wherein the wavelength band filter film is a narrowband reflector film.

10. (canceled)

11. The optical element of claim 1, wherein the wavelength band filter film comprises a metastructure, wherein the metastructure is a metasurface having a unit structure comprising one of the group consisting of: elliptical nanopillar pairs, rectangular nanopillars with notches, hollow nanopillars distributed in a square two-dimensional lattice, circular nanopillars periodically arranged in a square two-dimensional lattice, nanopillars with an elliptical cross-section periodically arranged in a square lattice, and multilayer nanopillars with a circular cross-section.

12. (canceled)

13. The optical element of claim 11, wherein the one or more nanopillars in the unit structure are provided in air; or
wherein the one or more nanopillars in the unit structure are encapsulated in an organic polymer material.

14. (canceled)

15. The optical element of claim 1, wherein the wavelength band filter film comprises a metastructure, wherein the metasurface has a unit structure comprising one or more multilayer nanopillars, wherein each multilayer nanopillar includes a base layer of Al₂O₃, an intermediate layer of TiO₂ formed on the base layer, and a top layer of SiO₂ formed on the intermediate layer.

16. The optical element according to claim 1, wherein the wavelength band filter film has a layer structure comprising one of alternating Al₂O₃/SiO₂ layers, alternating HfO₂/SiO₂ layers, alternating TiO₂/SiO₂ layers, and alternating Ta₂O₅/SiO₂ layers.

17. The optical element according to claim 1, further comprising a second wavelength band filter film having a second diffractive optical structure, wherein the second diffractive optical structure diffracts light including light in a second wavelength band so as to form a second array of optical focal points, the second wavelength band filter film selectively performs one of reflecting and transmitting the light in the second wavelength band, and selectively performs the other of reflecting and transmitting light outside the second wavelength band, and the second wavelength band does not overlap with the first wavelength band.

18. The optical element according to claim 17, further comprising a third wavelength band filter film having a third diffractive optical structure, wherein the third diffractive optical structure diffracts light including light in a third wavelength band so as to form a third array of optical focal points, the third wavelength band filter film selectively performs one of reflecting and transmitting the light in the third wavelength band, and selectively performs the other of reflecting and transmitting light outside the third wavelength band, and wherein the third wavelength band does not overlap with the first wavelength band or the second wavelength band.

19. The optical element according to claim 1, wherein the diffractive optical structure is a holographic optical structure.

20. A free space combiner or a waveguide combiner for an augmented reality or virtual reality device comprising the optical element of claim 1.

21. (canceled)

22. An augmented reality or virtual reality device comprising:
a combiner according to claim 20; and
a light source configured to project light onto the combiner to form an image,
wherein the light source is configured to project light having a wavelength within the first wavelength band.

23. An augmented reality or virtual reality device comprising:
a combiner comprising the optical element according to claim 17;
a first light source configured to project light onto the combiner to form an image, wherein the first light source is configured to project light having a wavelength within the first wavelength band; and
a second light source configured to project light onto the combiner to form an image, wherein the second light source is configured to project light having a wavelength within the second wavelength band.

24. An augmented reality or virtual reality device according to claim 23, further comprising a third light source configured to project light onto the combiner to form an image, wherein the third light source is configured to project light having a wavelength within a third wavelength band, wherein the third wavelength band does not overlap with the first wavelength band or the second wavelength band.

25. A virtual reality device according to claim 22, further comprising a light shield configured to block outside light from reaching the combiner.
